(19) United States
(12) Patent Application Publication
(10) Pub. No.: US 2008/0024663 A1
(43) Pub. Date: Jan. 31, 2008

(54) Content receiver terminal device with zapping response improved in viewing multi-channel video content

(75) Inventor: Koji Sakurada, Tokyo (JP)

Correspondence Address: VENABLE LLP, P.O. BOX 34385, WASHINGTON, DC, 20043-9998, US

(73) Assignee: Oki Electric Industry Co., Ltd., Tokyo (JP)

(21) Appl. No.: 11/822,651

(22) Filed: Jul. 9, 2007

(30) Foreign Application Priority Data
Jul. 27, 2006 (JP) 2006-205093

(51) Int. Cl. H04N 5/44

(52) U.S. Cl. 348/553; 348/E05.096

(57) ABSTRACT

A content receiver terminal device for receiving video content which belongs to one of plural channels and is distributed at two different bit rates includes a selector for selecting one of the channels, and a memory for receiving video content belonging to the channel selected and stores the video content received. The content receiver terminal device also includes a reproducer which, in case the channel selector has selected a new channel, first reads out and reproduces content of a lower bit rate of the video content from the memory, and subsequently reproduces content of a higher bit rate. Thus, when viewing multi-channel video content transmitted over a telecommunications network suffering from fluctuation in communication speed, the zapping response is improved.

### BACKGROUND OF THE INVENTION

1. Field of the Invention

The present invention relates to a content receiver terminal device configured for receiving multi-channel video content distributed over a telecommunications network.

2. Description of the Background Art

In distributing video content over a telecommunications network, it may occur that the network undergoes fluctuation in its communication or transmission speed. In order to solve such a fluctuation difficulty, the content receiver terminal device serving as a client is provided with a receiver buffer such as to compensate for the fluctuation. After a predetermined amount of data, for example, corresponding to ten seconds, has been stored in the buffer, the data is developed from the buffer to be reproduced. This prevents the reproduction of the data from being interrupted as would otherwise be ascribable to fluctuation in communication speed.

In that case, however, data is reproduced necessarily with delay, of which the time corresponds to an amount of data stored in the receiver buffer, e.g. ten seconds, in the content receiver terminal device.

In order to remove the delay problem, the streaming player system disclosed by Japanese patent laid-open publication No. 2006-80612 is adapted to download beforehand the beginning portions of streaming data of plural video contents into the content receiver terminal device. When one video content is selected or switched for viewing, the streaming player system starts receiving the content from a network and at the same time plays the beginning portion of the streaming data of that content downloaded in advance.

When the downloaded beginning portion of the content has completely been played, the predetermined amount of data might have been stored in the receiver buffer. The receiver buffer may be read from the portion continuing the beginning portion to thereby play the content in succession from the end of the beginning portion. The streaming player system of the Japanese '612 publication is thus structured to store and hold the beginning portions of contents beforehand so as to establish the viewing of content free of reproduction delay.

The technique of the Japanese '612 publication is effective for video content already recorded, indeed. It is however not so advantageously applicable to video content transmitted on a real-time basis, such as TV (television) broadcast. With real-time video content, it is difficult to prepare beforehand partial streaming data of video content.

When selecting or changing over video content in a content receiver terminal device, the content selected cannot be played until the receiver buffer is cleared and stores a predetermined amount of data of that content, with the result that the content receiver terminal device is deteriorated in response characteristics. In the context, the operation of selecting or changing over video content will be referred to below as zapping.

### SUMMARY OF THE INVENTION

It is an object of the present invention to provide a content receiver terminal device which is improved in response characteristics of zapping in viewing multi-channel video content over a telecommunications network undergoing fluctuations in communication or transmission speed.

In accordance with the present invention, a content receiver terminal device for receiving video content belonging to one of a plurality of channels and distributed at two different bit rates comprises a channel selector for selecting one of the channels, a buffer for receiving video content belonging to the channel selected and for storing the video content received, and a reproducer for first performing, in case the channel selector has selected a new channel, a preliminary reproducing operation of reading out and reproducing content of a lower bit rate of the video content from the buffer, and for subsequently performing an actual reproducing operation of content of a higher bit rate.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing a preferred embodiment of a content distribution server and a content receiver terminal device according to the present invention;

FIG. 2 is a time chart useful for understanding the operation of various parts of the content distribution server and the content receiver terminal device in accordance with the preferred embodiment;

FIG. 3 is a flow chart useful for understanding the operation of the content receiver terminal device in accordance with the preferred embodiment; and

FIG. 4 diagrammatically shows channel transition patterns as used in accordance with the preferred embodiment.

### DESCRIPTION OF THE PREFERRED EMBODIMENT

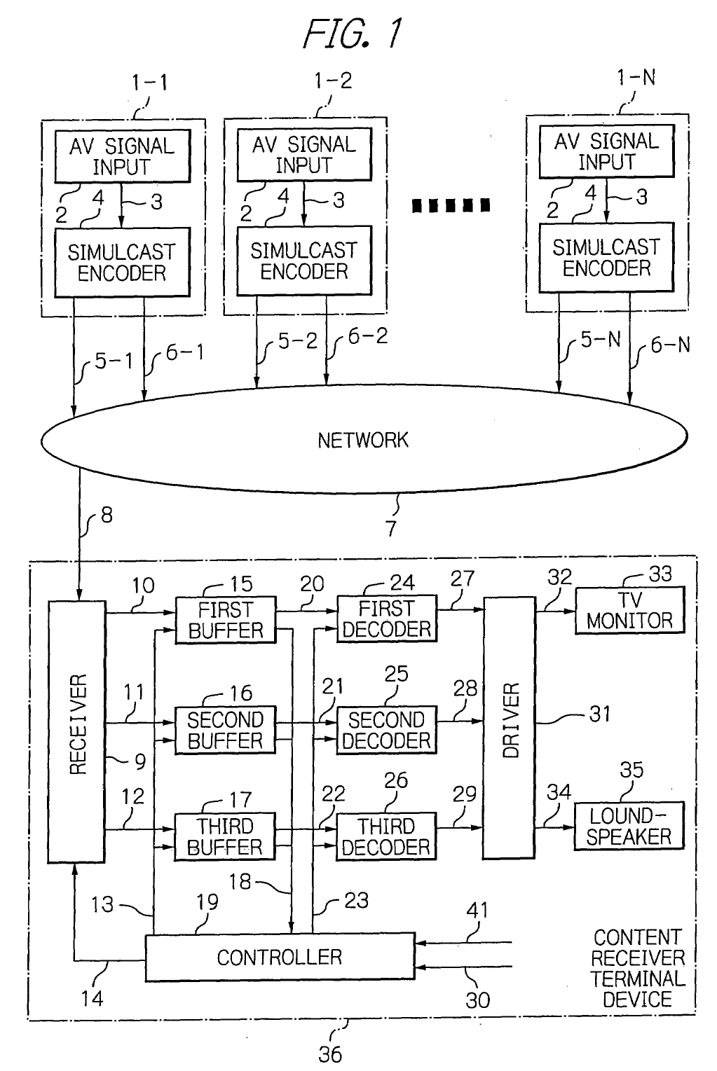

FIG. 1 is a schematic block diagram showing a preferred embodiment of a content distribution system in accordance with the present invention. The illustrative system is composed of a plurality (n) of channel distribution servers 1-N, where n is a natural number and N is an integer of from 1 to n, inclusive. The illustrative system further includes a telecommunications network 7, and a content receiver terminal device 36 functioning as a client, all those components being interconnected as illustrated. The channel distribution servers 1-N distribute video contents on the respective video channels to the network 7. Specifically, the channel distribution servers 1-1, 1-2 to 1-N are provided for channels #1, #2 to #n, respectively.

Each of the channel distribution servers 1-N comprises an audio and video (AV) signal input unit 2 and a simulcast encoder 4. The AV signal input unit 2 receives, e.g. TV broadcast signals carried on electromagnetic waves to output an AV signal 3 including a video and an audio signal. In the patent application, signals are designated with reference numerals of connections on which they are conveyed.

The simulcast encoder 4 receives the AV signal 3 and encodes the received signal 3 at two bit rates different from each other, i.e. higher and lower bit rates, to output resulting data over the network 7. The data with the higher bit rate is termed a content stream 5-N and the data with the lower bit rate is termed a reference stream 6-N.

The content stream 5-N and the reference stream 6-N, distributed from each of the channel distribution servers 1-N, are transmitted over the network 7 and a transmission line 8 to the content receiver terminal device 36.

The content receiver terminal device 36 is composed of a receiver 9, three buffers, i.e. first buffer 15, second buffer 16 and third buffer 17, three decoders, i.e. first decoder 24, second decoder 25 and third decoder 26, a driver 31, a TV monitor 33, a loudspeaker 35 and a system controller 19, which are interconnected as illustrated.

The receiver 9 receives transmitted data 8 and in turn produces, under the control of the system controller 19, three streams of data, i.e. first stream 10, second stream 11 and third stream 12, to the three buffers 15, 16 and 17, respectively.

Under the control of the controller 19, the buffers 15, 16 and 17 clear data already stored therein and newly store therein the data streams 10, 11 and 12 sent from the receiver 9, respectively.

The buffers 15, 16 and 17 are responsive to requests provided from the decoders 24, 25 and 26, respectively, to output the data stored in the respective buffers 15, 16 and 17 in the form of first buffer signal 20, second buffer signal 21 and third buffer signal 22, respectively, in a FIFO (First-In First-Out) fashion.

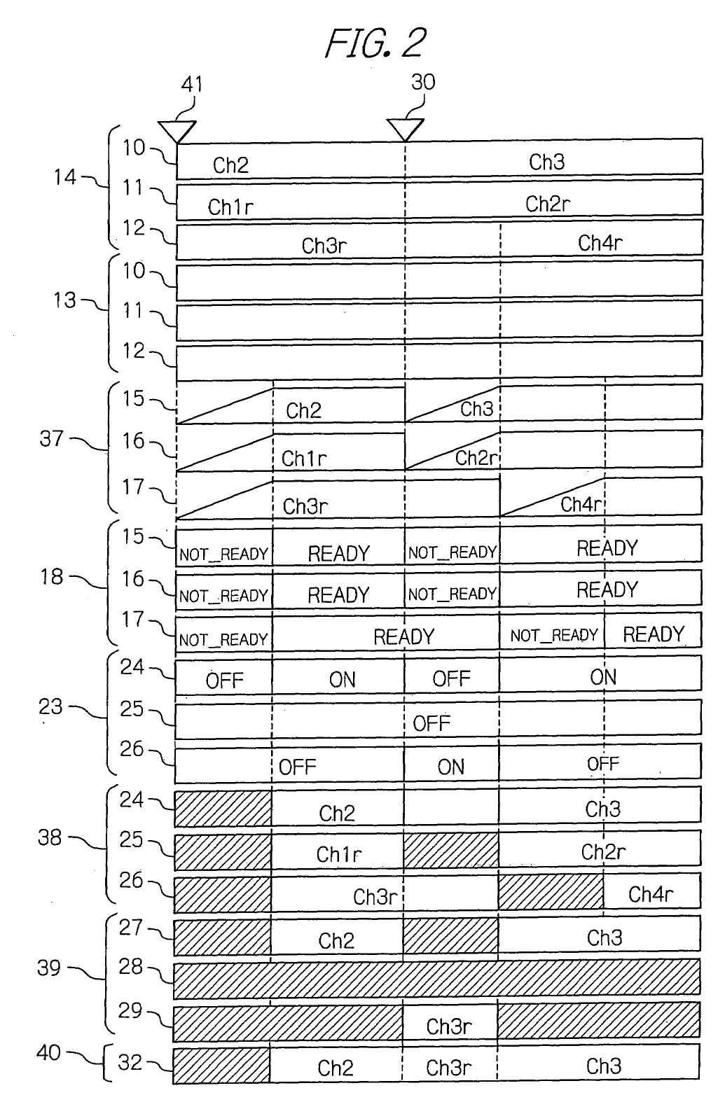

The buffers 15, 16 and 17 also output a buffer status signal 18 to the controller 19. The buffer status signal 18 indicates whether or not the volume or amount of data stored in the buffer is equal to or greater than a predetermined value. The amount of data stored in the buffer is referred to below as residual buffer data amount 37, FIG. 2.

The decoders 24, 25 and 26 receive the buffer signals 20, 21 and 22 from the buffers 15, 16 and 17, respectively. The decoders 24, 25 and 26 decode the respective signals received to generate and output three terminal AV signals, i.e. first terminal AV signal 27, second terminal AV signal 28 and third terminal AV signal 29, each of which includes video and audio signals.

The decoders 24, 25 and 26 receive from the controller 19 a decoder control signal 23 indicating whether to output terminal AV signals 27, 28 and 29, respectively, which will be described later. The decoders 24, 25 and 26 output terminal AV signals 27, 28 and 29 in case the decoder control signal 23 indicates that the terminal AV signals 27, 28 and 29 be output, respectively.

The driver 31 receives the terminal AV signals 27, 28 and 29, and produces therefrom a video signal 32 and an audio signal 34. The TV monitor 33 receives the video signal 32 from the driver 31 to reproduce or play and display video content represented by the video signal 32 in the form of visual image. The loudspeaker 35 receives the audio signal 34 from the driver 31 to reproduce the audio signal 34 received in the form of audible sound.

The controller 19 is responsive to a signal 30 corresponding to operation for zapping manually entered on an operation panel, not shown, and also to the buffer status signal 18 to supply a channel control signal 14 to the receiver 9 as well as to supply the buffer control signal 13 to the buffers 15, 16 and 17 and the decoder control signal 23 to one of the decoders, i.e. first decoder 24 in this example.

In the present embodiment, the content stream 5-N and the reference stream 6-N are output from each of the n channel distribution servers 1-N. The content receiver terminal device 36 is provided with a remote controller, not shown, which is adapted to be responsive to manipulation of the user so as to enable him or her to instruct a viewing and/or listening start, represented by a signal 41, or designate the channel number desired to be viewed or watched, represented by the zapping operation signal 30.

Now, reference will be made to FIG. 2, which is useful for understanding the operation of the content receiver terminal device 36 of the present illustrative embodiment. In operation, the content receiver terminal device 36 receives instructions for the viewing start 41 given by, e.g. the remote controller. The controller 19 then discriminates the bit rate of the received signal 8 and then imparts to the receiver 9 the channel control signal 14 indicative of a default value. It is assumed that the default value specifies the first stream afforded to the content stream 5-2 on the channel #2, the second stream afforded to the reference stream 6-1 on the channel #1 as a preliminary channel, and the third stream afforded to the reference stream 6-3 on the channel #3 as another preliminary channel.

The controller 19 transmits the buffer control signal 13 to the three buffers 15, 16 and 17 to clear their contents. This clears the contents of the three buffers 15, 16 and 17, which in turn change the respective buffer status signals 18 to NOT_READY, meaning that the respective residual buffer data amount 37 is only small, and output the signals 18 to the system controller 23.

The receiver 9 receives the three channel streams as set from the controller 19, and in turn the streams of data will gradually be stored in the respectively three buffers 15, 16 and 17. The controller 19 then detects the residual buffer data amount 37 from the buffer status signals 18. If the controller 19 finds the residual data amount 37 to be small, then it turns the decoder control signal 23 off, i.e. to its disable state. The three decoders 24, 25 and 26 thereby do not start decoding 38, FIG. 2, thus no output being developed on the display screen of the TV monitor 33 and on the loudspeaker 35.

If the buffers 15, 16 and 17 determine that the respective residual buffer data amounts 37 have reached the predetermined value, then they turn the buffer status signal 18 to READY, meaning that the residual buffer data amounts 37 are not less than the predetermined value.

The system controller 19 instructs the decoders 24, 25 and 26 to start decoding 38 by the decoder control signal 23. The controller 19 turns the first decoder 24 on by the decoder control signal 23 instructing the first stream 10 received as a content stream 5-2 on the channel #2 to be visualized on the display screen of the TV monitor 33 and output to the loudspeaker 35, thus enabling the first decoder 24 to output the first AV signal 27 as a decoder output signal 39, FIG. 2.

On the other hand, to the second decoder 25 and the third decoder 26, the system controller 19 provides the decoder control signal 23 instructing both of them to be turned off, i.e. disabled. Thus, both decoders 25 and 26 performs decoding internally so as to output neither the second terminal AV signal 28 nor the third terminal AV signal 29 to the driver 31. Thence, the video signal 32 and the audio signal 34, corresponding to the content stream 5-2 on the channel #2, will be output on the display screen of the TV monitor 33 and on the loudspeaker 35, respectively, as depicted as a reproduction of received data 40 in FIG. 2.

Now, the operation of selecting the channel #3 will be carried out by using, e.g. the remote controller. This process is represented as zapping 30, which will now be described with reference to FIG. 2 again. In response, the controller 19 determines the bit rate of the received signal 8 and detects that the reference stream 6-3 on the channel #3 exists on the third stream 12.

The controller 19 then transmits the buffer control signal 13 to clear the contents of the first buffer 15 and the second buffer 16 corresponding to the other streams. The first buffer 15 and the second buffer 16 change the buffer status signals 18 to NOT_READY.

The controller 19 then outputs the channel control signal 14 to allocate the content stream 5-3 on the channel #3 to the first stream 10 and to allocate a reference stream 6-2 on the channel #2 to the second stream 11. The controller 19 begins to store the content stream 5-3 on the channel #3 in the first buffer 15 and to store the stream data of the reference stream 6-2 on the channel #2 in the second buffer 16.

The controller 19 also turns the first decoder 24 and the second decoder 25 off by the decoder control signal 23. The controller 19 further instructs the third decoder 26 to be turned on, the third decoder 26 corresponding to the reference stream 6-3 on the channel #3.

The residual buffer data amount of the first buffer 15 is detected, and, if the residual data amount is found to be not sufficient, the video signal 32 and the audio signal 34, corresponding to the reference stream 6-3 on the channel #3, are output on the display screen of the TV monitor 33 and the loudspeaker 35, as from the time point of the zapping operation 30.

The residual buffer data amounts of the first buffer 15 and the second buffer 16 once become zero. Subsequently, data of the content stream 5-3 on the channel #3 and the reference stream 6-2 on the channel #2 are gradually stored in the first and second buffers, respectively.

When it is determined that the residual buffer data amount of the first buffer 15 has reached the predetermined value, the buffer status signal 18 for the first buffer 15 changes to READY. Upon detection that the first buffer 15 is READY, the controller 19 instructs the first decoder 24, dealing with the content stream 5-3 on the channel #3, to be turned on by the decoder control signal 23, and turns off the second decoder 25 and the third decoder 26.

This causes the video signal 32 and the video signal 34, corresponding to the content stream 5-3 on the channel #3, to be output on the display screen of the TV monitor 33 and on the loudspeaker 35, respectively.

The controller 19 outputs the buffer control signal 13 to clear the third buffer 17, while outputting the channel control signal 14 to the receiver 9 to cause the reference stream 6-4 on the channel #4, as the preliminary channel, to be stored in the third buffer 17.

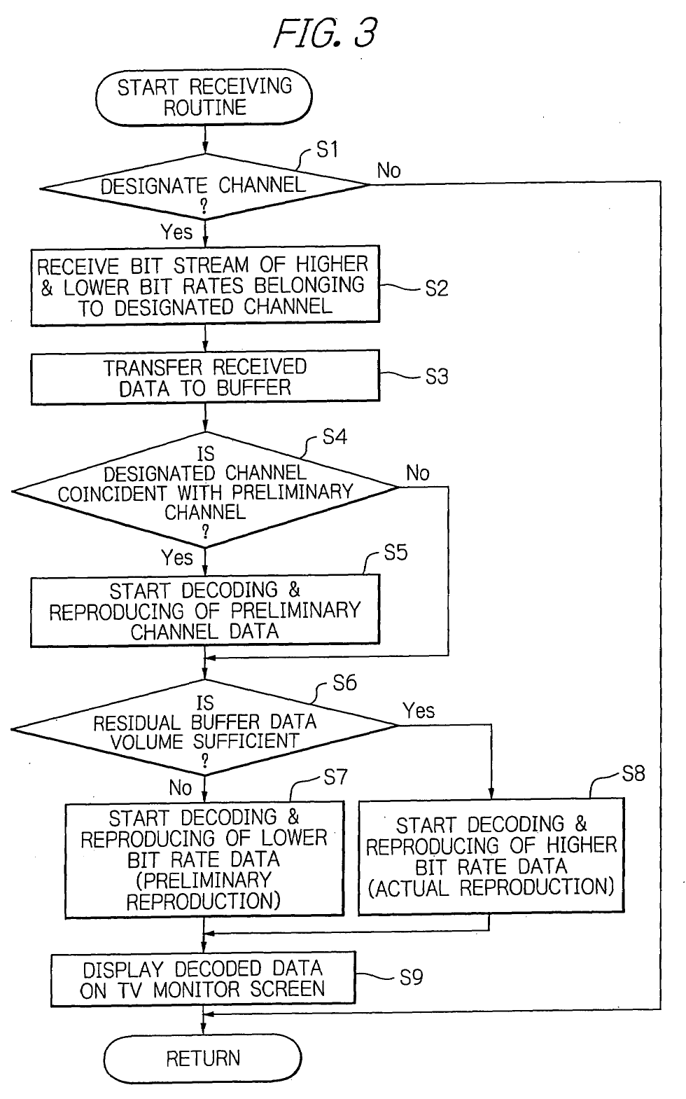

In the foregoing, the operation of the content receiver terminal device 36 has been described separately for viewing start and for zapping. The receiving routine of the receiver terminal device 36 will now be briefly described with reference to FIG. 3.

This receiving routine is carried out by the controller 19, e.g. at a predetermined time interval. When the processing enters the receiving routine, it is checked whether or not a new channel has been designated (step S1). If a new channel has been designated, bit streams of higher and lower bit rates of the designated channel are received (step S2).

The data received are then transmitted to the buffer (step S3). It is checked whether or not the designated channel and the preliminary channel are coincident with each other (step S4). When the designated channel and the preliminary channel are coincident with each other, the preliminary channel data start to be decoded and reproduced (step S5). When the designated channel and the preliminary channel are not coincident with each other, the preliminary channel data are not decoded or reproduced.

It is then checked whether or not the residual buffer data amount is sufficient (step S6). In case the residual buffer data amount is found to be insufficient, received data of the lower bit rate are decoded and reproduced (step S7). The received data are reproduced in the form of preliminary reproducing or playing operation on the screen of the TV monitor 33 and by the loudspeaker 35. In the step S6, if the residual buffer data amount 37 is found to be sufficient, then the received data of the higher bit rate are decoded (step S8) and reproduced in the form of actual reproducing or playing operation on the screen of the TV monitor 33 and by the loudspeaker 35 (step S9).

In the foregoing description, a default channel is designated at the time of viewing start and bit streams of both higher and lower bit rates are captured. However, capturing the bit stream of the lower bit rate may be dispensed with.

The zapping operation 30 for the channel #3 has been described in a case where the channels #2 and #4 are selected as reference streams and received simultaneously. The instant illustrative embodiment uses the statistic information of transition patterns of past viewing or watching channels to settle two channels of higher transition probability or channels neighboring to the channel presently under reception as preliminary channels and to simultaneously receive the content of the lower bit rate on the so settled preliminary channels as reference streams, thereby improving zapping response characteristics. In that manner, the content receiver terminal device 36 utilizes the channel selecting histories of the users and holds the transition patterns of the past viewing channels.

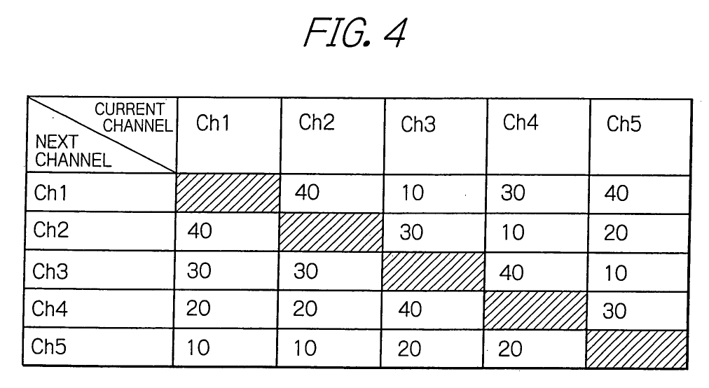

FIG. 4 will be used for describing the channel control operation by the system controller 19, and specifically shows, for the case of n=5, the probabilistic distribution of the combinations of channel numbers currently viewed as a content stream and a content stream to be viewed next. For instance, the probability of transition from the channel #3 is the channels #4, #2, #5 and #1 in the falling order of the probability. If the content stream is thus the channel #3, then the channels #4 and #2 are selected as the reference streams, which are adapted to be received simultaneously.

In the present embodiment, the content receiver terminal device 36 simultaneously receives and decodes reference streams on two channels distinct from the content stream currently being viewed. When changing over the content stream desired to be viewed, if the reference stream corresponding to the channel desired to be viewed has already been received, this reference stream will be reproduced or played, and at the same time the content stream on that channel will be received. Thereafter, when that content stream has become playable, the channel is changed over to the content stream, which will then be reproduced.

In the above-described embodiment, reference streams on two channels are received simultaneously with a designated channel. Alternatively, the system may be adapted such that a reference stream on a single channel is received simultaneously with a designated channel.

In the above-described embodiment also, so far as a reference stream is received, the decoders continue in decoding operation. Alternatively, the system may be structured such that the decoders operate only during the time when a decoding output is required by the subsequent driver 31.

The entire disclosure of Japanese patent application No. 2006-205093 filed on Jul. 27, 2006, including the specification, claims, accompanying drawings and abstract of the disclosure, is incorporated herein by reference in its entirety.

While the present invention has been described with reference to the particular illustrative embodiment, it is not to be restricted by the embodiment. It is to be appreciated that those skilled in the art can change or modify the embodiment without departing from the scope and spirit of the present invention.

What is claimed is:

1. A content receiver terminal device for receiving video content which belongs to one of a plurality of channels and is distributed at higher and lower bit rates, comprising:
a channel selector for selecting one of the plurality of channels;
a buffer for receiving video content belonging to the channel selected and for storing the video content received; and
a reproducer operative in response to said channel selector for reproducing the video content belonging to the channel selected,
said reproducer performing, when said channel selector has selected new one of the plurality of channels, a preliminary reproducing operation of reading out content of the lower bit rate of the video content from said buffer and reproducing the content read out, and subsequently performing an actual reproducing operation of reproducing content of the higher bit rate of the video content.

2. The content receiver terminal device in accordance with claim 1, wherein said reproducer includes:
a decoder for decoding each of the video contents of the higher and lower bit rates belonging to the one channel;
a display monitor for selectively displaying either of the decoded video contents output from said decoder; and
a controller for controlling said decoder and said monitor for selectively performing the preliminary reproducing operation and the actual reproducing operation.

3. The content receiver terminal device in accordance with claim 1, wherein said buffer also stores video content belonging to a preliminary channel associated with the one channel selected;
said reproducer reading out the video content belonging to the preliminary channel from said buffer prior to the preliminary reproducing operation and reproducing the video content read out.
